(19) United States
(12) Patent Application Publication
(10) Pub. No.: US 2009/0323465 A1
(43) Pub. Date: Dec. 31, 2009

(54) MIXER

(75) Inventor: Knud Simonsen, Slagelse (DK)

Correspondence Address: DOBRUSIN & THENNISCH PC, 29 W LAWRENCE ST, SUITE 210, PONTIAC, MI, 48342, US

(73) Assignee: CFS BAKEL B.V., EN Bakel (NL)

(21) Appl. No.: 12/307,471

(22) PCT Filed: Jul. 6, 2007
(86) PCT No.: PCT/EP07/06020

§ 371 Date: Sep. 1, 2009

(30) Foreign Application Priority Data
Jul. 7, 2006 (EP) 06014129.8

(51) Int. Cl. B01F 7/04; B01F 15/02

(52) U.S. Cl. 366/172.1; 366/297; 366/300

(57) ABSTRACT

The present invention is related to an apparatus for massaging and/or tumbling of a product with a drum and a shaft with paddles rotated by a motor.

The present invention is related to an apparatus for massaging and/or mixing of a product with a drum and a shaft with paddles rotated by a motor.

The present invention further relates to a process for the control of the massaging and/or mixing of a product.

Products, especially meat, are nowadays often tumbled or massaged in a brine and/or a marination liquid in order to marinade and/or tenderize the product for the consumer. This process is carried out in an apparatus for massaging and/or tumbling known for example from U.S. Pat. No. 5,362,507, U.S. Pat. No. 5,972,398, U.S. Pat. No. 5,405,360, US 2002/0006457, US 2002/0139254, US 2002/0102341, US 2004/0142076 and US 2004/166229. These tumblers, however, have the disadvantage, that they are not easily operated, maintained and/or inspected, because they have only a manhole, via which the drum is accessible.

It is therefore the objective of the present invention to provide an apparatus for massaging and/or mixing a product that does not have the disadvantages of the state of the art.

This problem is solved by an apparatus for massaging and/or tumbling of a product with a drum and a shaft with paddles rotated by a motor, wherein the drum comprises a top-lid.

It was totally surprising and could not have been expected by a person skilled in the art, that the inventive apparatus has excellent massaging and/or mixing properties and is nonetheless easily operated inspected and maintained.

The product that is tumbled and/or massaged in the inventive apparatus can be any product known by a person skilled in the art. However, preferably, the product is meat or a meat comprising substance. This substance is tumbled or massaged in a brine or a marination liquid in order to marinade or tenderize the meat. The massaging or tumbling is achieved by paddles which are arranged on a rotating shaft. Due to the paddles, the meat and the brine and/or marination liquid are moved, so that a constant mixing and the massaging of the muscles & meat parts takes place.

According to the present invention, the apparatus comprises a top lid. This top lid is arranged at top of the apparatus and not at the end-faces, preferably and can be opened, so that the entire drum is easily accessible for insertation of the product but also to inspect, maintain and/or clean the drum, the shaft and the paddles. For opening and closing, the lid is preferably connected to the drum with hinges. Preferably the lid is hinged around an essentially vertical axis.

Preferably, the top lid has a curved inside surface. This inside surface preferably completes the drum to a complete cylinder, when the lid is closed. This prevents, that for example large muscles from being pinched, i.e. damaged during the tumbling and/or massaging process. Preferably, the curved inside surface of the lid comprises seals, which co-operate with the drum of the inventive apparatus in order to provide a completely sealed cylindrical drum.

Preferably, the lid extends essentially over the entire length and essentially over the entire width of the drum, so that blind inside angles are eliminated, which is advantageous for the inspection and maintenance of the inventive apparatus but also for the hygiene.

Preferably, the lid or the inside surface comprise a tempering means in order to heat or cool this part of the drum.

In an other preferred embodiment of the present invention, not only the circumference of the inventive apparatus, but at least one, more preferably both end-faces of the drum are tempered as well. This increases the tempering surface or the tempering capacity up to 30%, so that either the cooling capacity can be increased and/or the inventive apparatus can be operated with tempering fluids with a comparatively modest temperature.

Preferably, the paddles on the rotating shaft are designed such, that they create a circulation pattern within the brine/product mixture that is oriented parallel to the longitudinal axis of the shaft. This pattern avoids, that there are volumes within the drum, that are not massaged and/or mixed. Thus, a 100%-coverage of the volume within the drum is achieved

Preferably, the shaft of the inventive apparatus comprises outside and inside paddles. More preferably, the outside paddles move the product in one direction, e. g. towards one end face of the drum, while the inside paddles move the product in the opposite direction, e. g. towards the other end face of the drum. Due to this design, the circulation pattern within the product/liquid mixture is achieved. Preferably, the outside and inside paddles are located directly opposite of each other at the shaft.

In the end-face regions, the outside paddles have preferably extensions, in order to assure that they extend until the end-face of the drum, in order to achieve a 100% surface coverage.

Preferably, the paddles comprise tempering means to heat or cool the product inside the drum.

In a preferred embodiment of the present invention, the paddles are arranged such on the surface, that they are exchangeable. This features allows application of different paddles design for individual products. More preferably, the exchange of the paddles takes place without removing the shaft from the inventive apparatus. Most preferably the exchange of the paddles is executed via the top lid of the inventive apparatus. In an even more preferred embodiment of the invention, the inventive apparatus comprises injection nozzles, which are either oriented at the bottom or at the wall of the drum or on the surface of the paddles. With these nozzles, gas and/or a liquid and/or dry materials can be injected in order to treat the product in the drum.

An other aspect of the present invention is a process for the control of the tumbling and/or massaging of a product. The Massager/Mixer can be controlled in different ways, e. g. by means of maintaining a constant speed(and varying torque). When the speed is constant, normally the torque will increase in time as the product gets more sticky. The massager can also be controlled by maintaining a constant power, and by regulating the speed to ensure that the power consumption is at a certain predefined level. This will give a constant amount of energy per time added to the product. Furthermore, the massager can also be controlled by maintaining a constant torque. The speed is regulated to ensure that the torque is at a certain predefined level. Additionally, the massager can be controlled such that the speed is changed between predefined levels, high and low (pulsation of the speed). The high speed will throw the product to the top of the product chamber and the low speed will let the product fall down. This will treat the product according to the present invention. Furthermore, the massaging direction can be chosen/changed clockwise or counter clockwise in the individual massaging steps. The tumbling and/or massaging is stopped after a certain accumulated energy-input wherein the power provided to the product is given by the torque multiplied by speed of rotation of the paddles.

The inventive process has the advantage, that the product is not tumbled or massaged for a certain period of time, but until a certain energy input has been achieved, which is sufficient for the tumbling and/or massaging. Thus, the product is not treated beyond its optimal point and/or no energy is wasted.

The energy consumption can be monitored for example by a process control unit. Immediately after a certain energy input has been achieved, this control unit automatically stops the tumbling and /or massaging process.

In another inventive or preferred embodiment, the tumbling and/or massaging process is stopped after a certain torque at the shaft has been reached.

This inventive process also assures, that the meat is not treated too short or even beyond its optimal point.

Normally, when the process is started, a relatively low torque is needed in order to rotate the shaft with the paddles. This torque increases, while the product is tenderized. After the torque has reached a certain value and/or has increased by an predetermined amount, the process is stopped automatically, and the product within the drum can be discharged

In an other preferred or inventive embodiment, the tumbling and/or massaging process is terminated after a certain marinade or brine uptake of the meat. This can be measured for example by the liquid level within the drum or by the change of torque.

This inventive process also assures, that the meat is not treated too short or even beyond its optimal point.

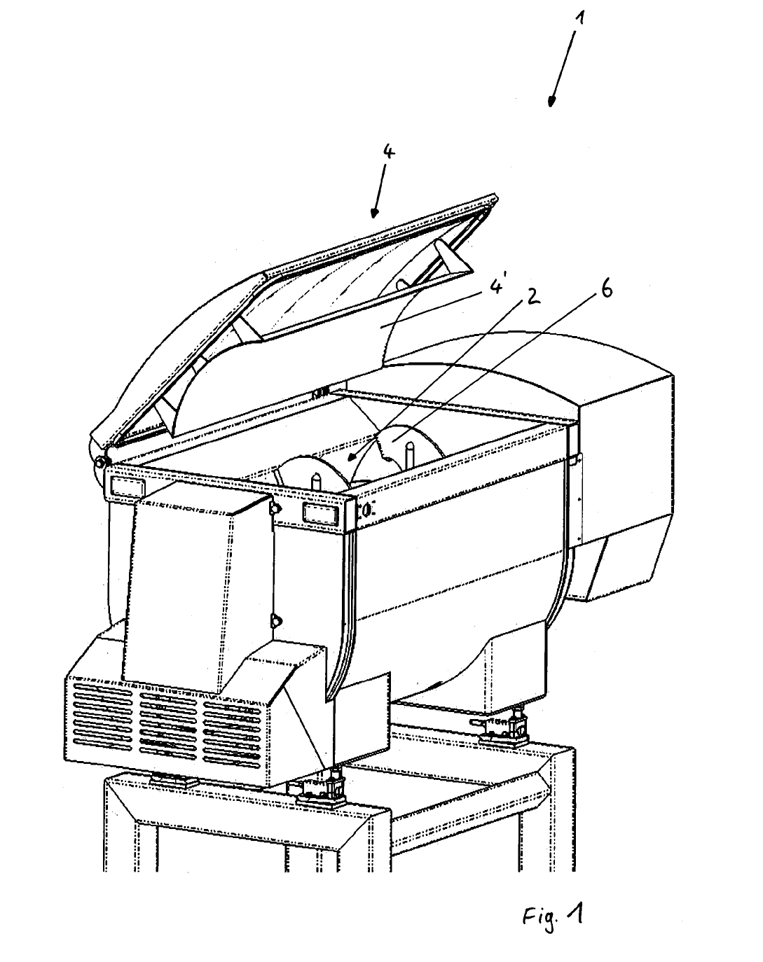

The inventive apparatus and/or the inventive processes are now described according to FIGS. 1-10. These descriptions do not limit the scope of protection of the present invention.

FIG. 1 shows one embodiment of the inventive apparatus.

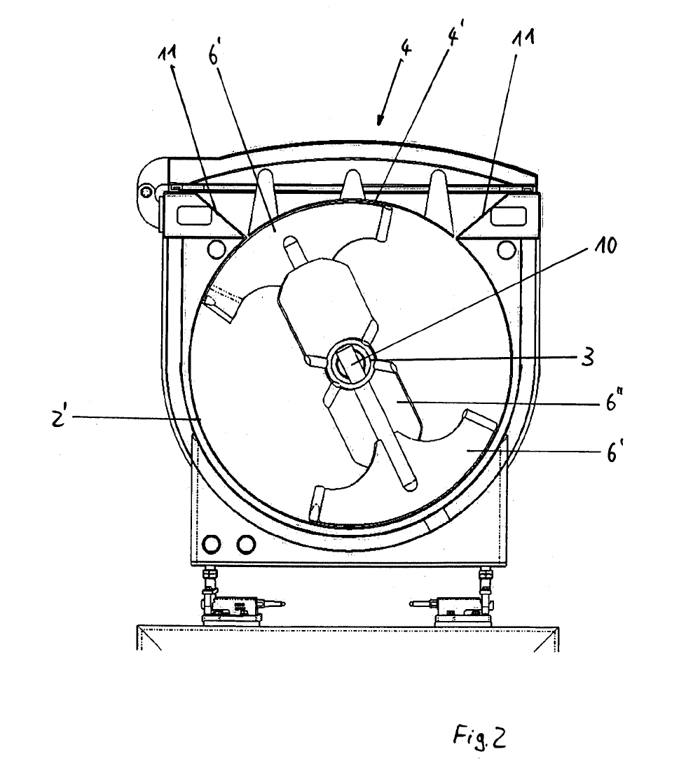

FIG. 2 shows the drum with the shaft and the paddles.

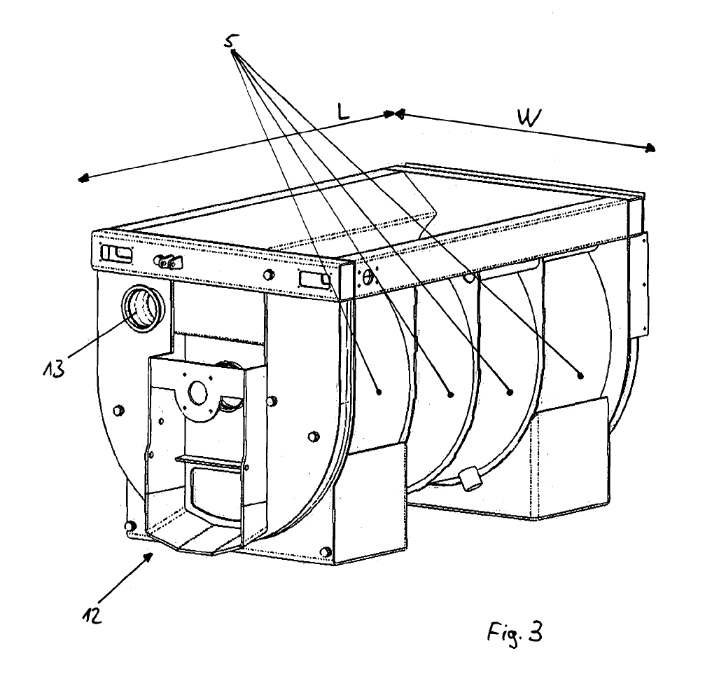

FIG. 3 shows the tempering means and the circumference of the drum

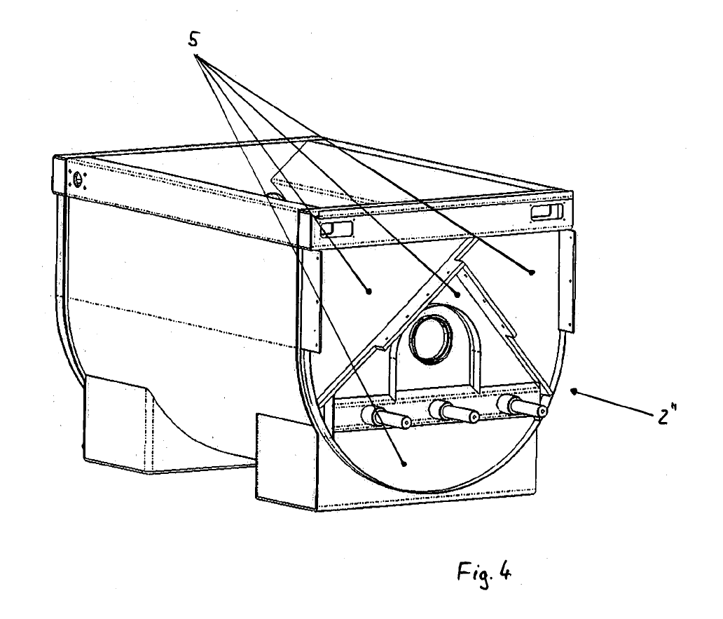

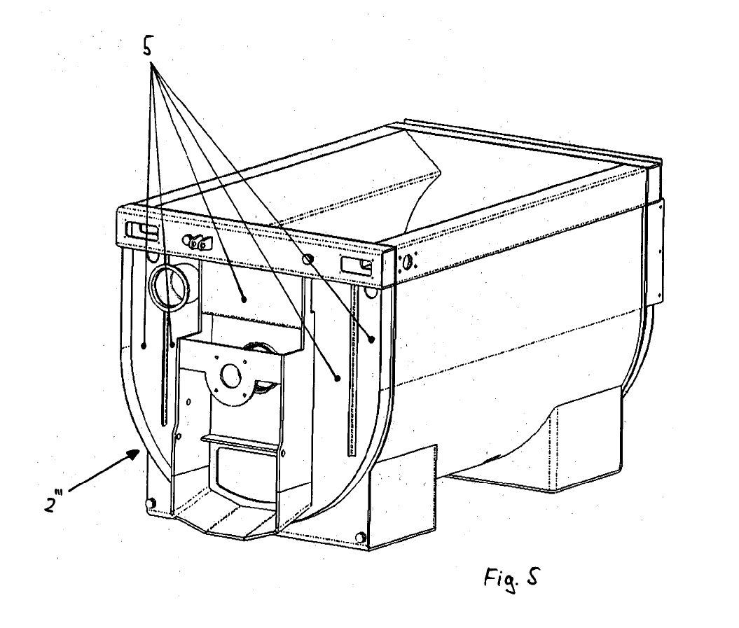

FIGS. 4 and 5 show the tempering means at the end-faces.

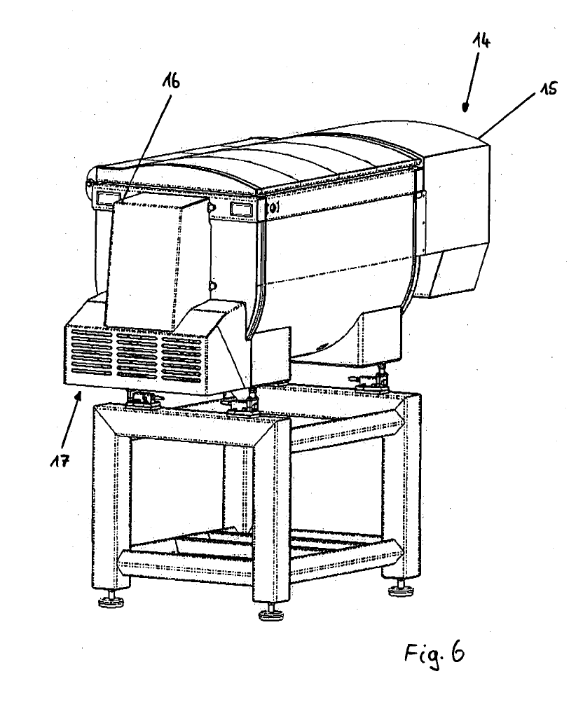

FIG. 6 shows the covers for the motor and the discharge area.

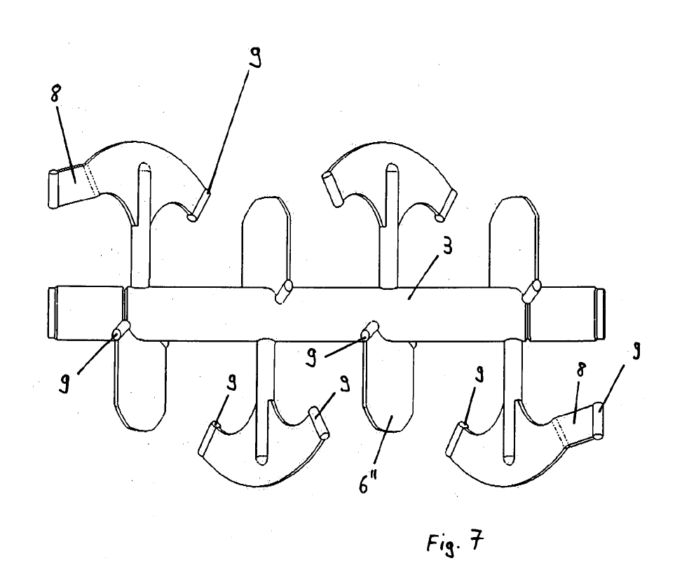

FIG. 7 shows the shaft with the paddles.

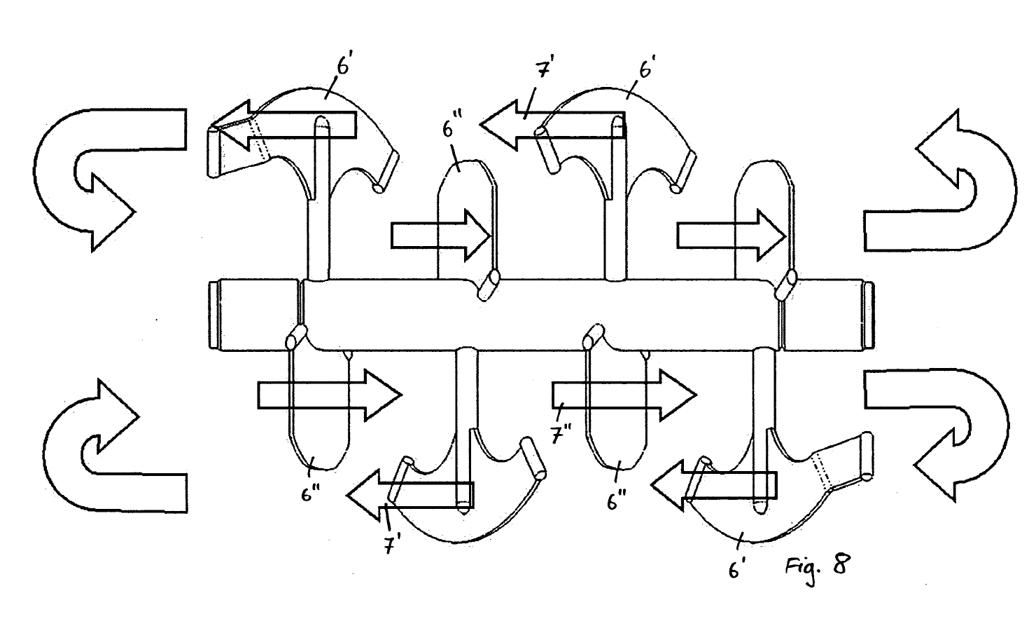

FIG. 8 shows the circulation pattern around the rotating shaft.

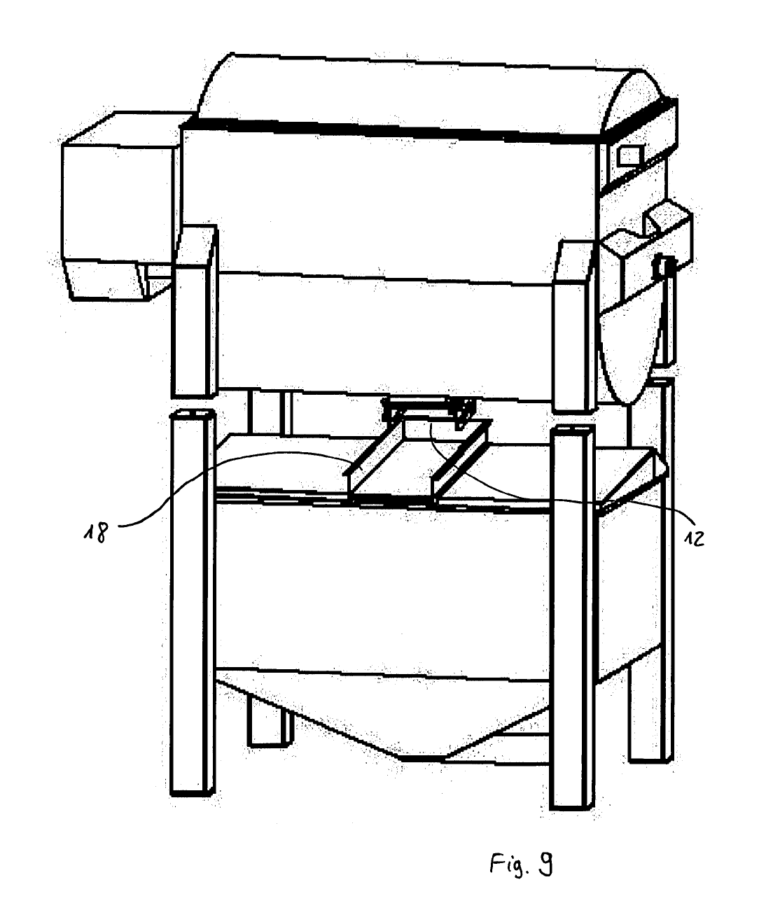

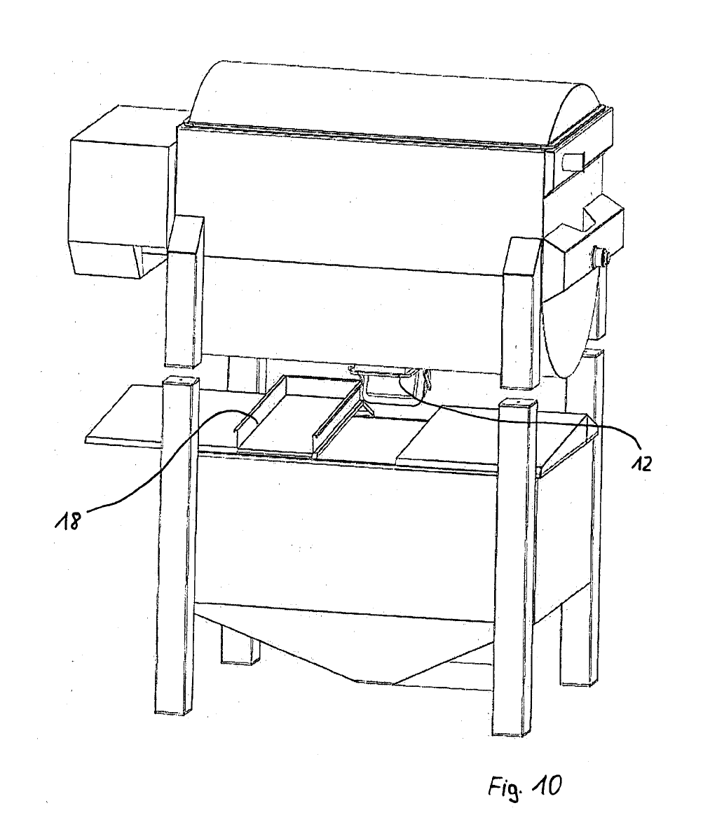

FIGS. 9 and 10 show the inventive apparatus with the possibility of discharging the apparatus at the middle and with a buffer tank under the mask.

FIG. 1 shows the inventive apparatus 1 for massaging and/or mixing a product, for example meat. The apparatus 1 comprises a cylindrical drum 2. The centerline of the drum is oriented essentially horizontally. Within this drum, a rotating shaft with paddles 6 is arranged. The inventive apparatus further comprises a top lid 4, so that the apparatus is accessible from the top. This makes an inspection, maintenance and/or cleaning of the drum much easier in comparison to machines according to the state of the art. At one side, the top lid is hinged to the casing of the drum. The lid extends over the entire width and the entire length of the drum, so that there are no non accessible spots within the drum. Within the lid 4, an inside surface 4′ is arranged. This inside surface 4′ is designed such, that it completes the drum to a complete cylinder when the lid 4 is closed. At the circumference of the surface 4′a seal can be arranged.

FIG. 2 shows a cut through the inventive apparatus. It can be clearly seen, that the inventive apparatus comprises a drum 2 with a circumference-wall 2′. The cylindrical shape of the drum is completed by the inside surface 4′ of the lid 4. Thus, theses two parts 2′, 4′ form an entire cylinder. Furthermore, the circumference-wall 2′ comprise guiding means 11, so that any product or brine is guided to the drum. Inside the drum, a rotating shaft 3 is arranged, the rotating shaft 3 being ?? in bearings at the two end faces of the drum. The shaft 3 can be rotated by a motor. The shaft 3 comprises holes, that take up shafts 10 of the paddles 6, so that the paddles can be mounted easily on the shaft 3. As can be seen from this cut view of the inventive apparatus, on the shaft 3 there are outside paddles 6′ and inside paddles 6″. The paddles 6′, 6″ are designed such that a 100% volume coverage of the mixing is achieved.

FIG. 3 shows the inventive apparatus without its casing. It becomes clear that around the circumference walls 2′ of the drum, tempering means 5 are arranged, so that the drum can be heated or cooled. Additionally, this view shows and inlet 13, through which the product, for example meat or the brine and/or the marination liquid are sucked into the drum via vacuum. After the tumbling and/or massaging has taken place, the product is discharged out of the drum via the outlet 12.

FIGS. 4 and 5 show the tempering means 5 at the two end faces 2″, 2′″ of the drum of the inventive apparatus.

FIG. 6 shows that the apparatus comprises a motor 14 in order to rotate the shaft. This motor 14 is covered by a cover 15. In this figure, it can also be seen, that the outlet as well as the mechanics 17 to open and close the outlet are also covered by a cover 16. This cover 16 improves the hygiene of the massage and of the tumbled product.

FIG. 7 shows the shaft 3 with the outside paddles 6′ and the inside paddles 6″. The inside and the outside paddles are arranged directly opposite to each other. At their tips, the paddles comprise damage protectors 9 in order to avoid that the meat product is damaged during the massaging and/or tumbling. The outside paddles 6′ in the end face region comprise extensions 8 in order to achieve, that the outside paddle extends until the end face of the drum, in order to achieve a 100% surface coverage during the mixing.

The flow pattern achieved in the drum is depicted in FIG. 8. It can be seen, that circulation pattern 7 are achieved, which extend essentially parallel to the longitudinal access of the shaft 3, which rotates. Due to these circulation pattern, very good massaging and tumbling mixing results are achieved and it is assured that there are no dead spots within the drum in which the product is not massaged and/or tumbled, e. g. mixed sufficiently. The outside paddles 6′ move the product in one direction 7′ towards one of the end face, e. g. paddles 6″ move the product (e. g. meat muscles) in the opposite direction 7″ towards the other end face of the drum. This is achieved due to the shape and the orientation of the paddles.

In FIGS. 9 and 10, the inventive apparatus according to another embodiment is shown. In this embodiment, the apparatus has a discharge opening (outlet) 12 in the middle of the apparatus and a buffer tank under the machine. A discharge means 18 is provided shiftable at the discharge opening (outlet) 12 in a closed position (FIG. 9) and in an open position (FIG. 10).

### REFERENCE LIST

1 Apparatus

2 drum

2′ circumference of the drum

2″, 2′″ end face(s) of the drum

3 shaft

4 lid

4′ inside surface of the lid

5 tempering means

paddles

6′ outside paddle

6″ inside paddle

7 direction

7′ one direction

7″ opposite direction

8 extensions of the paddles

9 damage protectors

10 shaft of the paddle

11 guiding means

12 outlet

13 inlet

14 motor

15,16 cover

17 mechanics to open/close the outlet

L Length

W Width

1. Apparatus for massaging and/or mixing of a product with a drum and a shaft with paddles rotated by a motor, characterized in, that the paddles create a circulation—pattern parallel to the longitudinal axis of the shaft.

2. Apparatus according to claim 1, characterized in, that the apparatus includes a top-lid, and the top-lid has a curved inside surface.

3. Apparatus according to claim 2, characterized in, that lid extends essentially over the entire length (L) of the drum and/or essentially over the entire width (W) of the drum.

4. Apparatus according to claim 2 characterized in, that the lid and/or the inside surface comprises tempering means.

5. Apparatus according to claim 1, characterized in, that it comprises tempering means at the circumference and at one or both end-face(s).

6. Apparatus according to claim 1, characterized in, that the drum comprises a top-lid.

7. Apparatus according to claim 2, characterized in, that it comprises outside- and inside-paddles.

8. Apparatus according to claim 7, characterized in, that the outside-paddles move the product in one direction, while the inside-paddles move the product in the opposite direction.

9. Apparatus according to claim 8, characterized in, that paddles are located opposite of each other at the shaft.

10. Apparatus according to claim 7 characterized in, that it comprises outside-paddles in the end-face regions that have extensions.

11. Apparatus according to claim 1, characterized in, that the paddles comprise tempering-means.

12. Apparatus according to claim 2, characterized in, that the paddles are exchangeable, preferably via the top-lid.

13. Apparatus according to claim 1, characterized in, that the paddles comprise means to avoid damage of the product.

14. Apparatus according to claim 1, characterized in, that it comprises injection nozzles at the bottom or at the walls of the drum.

15. Process for the control of the massaging and/or mixing of a product, characterized in, that the tumbling and/or massaging is stopped after a certain torque at the shaft has been reached.

16. Process according to claim 15, characterized in, that the tumbling and/or massaging is terminated after a certain marinade or a brine uptake.

17. Apparatus according to claim 7, characterized in, that the outside-paddles move the product in one direction, while the inside-paddles move the product in the opposite direction.

18. Apparatus according to claim 4, characterized in, that it comprises outside-paddles and inside-paddles, and the outside-paddles move the product in one direction, while the inside-paddles move the product in the opposite direction.

19. Apparatus according to claim 3, characterized in, that the lid and/or the inside surface comprises tempering means.

20. Apparatus according to claim 19, characterized in, that paddles are located opposite of each other at the shaft, the paddles comprise inside-paddles and outside-paddles, and that the outside-paddles move the product in one direction, while the inside-paddles move the product in the opposite direction.
